(19) United States
(12) Patent Application Publication
(10) Pub. No.: US 2019/0075795 A1
(43) Pub. Date: Mar. 14, 2019

(54) FORMULATIONS FOR KILLING BITING ARTHROPODS

(71) Applicant: BEDOUKIAN RESEARCH, INC., Danbury, CT (US)

(72) Inventor: Robert H. BEDOUKIAN, West Redding, CT (US)

(21) Appl. No.: 16/128,931

(22) Filed: Sep. 12, 2018

Related U.S. Application Data
(60) Provisional application No. 62/557,267, filed on Sep. 12, 2017.

(51) Int. Cl. A01N 43/16; A01N 43/08; A01N 31/08; A01N 35/06; A01N 37/18; A01N 37/42

(52) U.S. Cl. CPC A01N 43/16; A01N 43/08; A01N 37/42; A01N 35/06; A01N 37/18; A01N 31/08

(57) ABSTRACT

Killing one or more biting arthropods selected from the group consisting of mosquitoes, bed bugs and ticks is accomplished by bringing the biting arthropods into contact with a toxic amount of a formulation comprising: (1) one or more compounds of structure (I), wherein the compounds of structure (1) comprise:

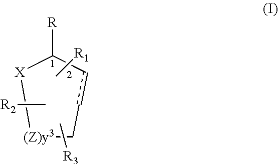

wherein R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms; X is O or CH₂, with the proviso that when X is O, then R can only be ═O; each Z is independently selected from the group consisting of (CH) and (CH₂); y is a numeral selected from 1 and 2; R₁ is selected from the group consisting of H or a branched or straight chain, saturated or unsaturated hydrocarbyl group with zero to two double bonds and from 1 to 15 carbon atoms; R₂ is selected from the group consisting of H and a branched or straight chain, saturated or unsaturated hydrocarbyl group with zero to three double bonds and from 1 to 15 carbon atoms; R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12; the bond between the 2 and 3 positions in the ring structure may be a single or a double bond; and wherein the compounds of structure (1) contain from 11 to 20 total carbon atoms.

### BACKGROUND OF THE DISCLOSURE

### 1. Related Applications

This application claims the benefit of U.S. Provisional Application Ser. No. 62/557,267, filed Sep. 12, 2017, which is incorporated herein by reference.

### 2. Field of the Disclosure

This disclosure relates to formulations used to kill biting arthropods, especially insects and arachnids.

### 3. Description of the Related Art

Many mammals, including humans, have suffered the action of biting arthropods, including mosquitoes, bed bugs and ticks. The blood sucking of mosquitoes results in an itching sensation and often a rash. Also, many mosquitoes cause potentially life-threatening illness. Aedes aegypti can cause dengue fever and yellow fever, Anopheles quadrimaculatus can cause malaria and Culex quinquefasciatus can cause West Nile disease.

Also, recent data suggests bedbug infestations (Cimex species) of human domiciles are on the rise. As with mosquitoes, bed bugs feed on human blood. At least 92 species of bed bugs have been identified globally, of which at least 16 species are in the North American continent. Generally, bed bugs are parasitic pests with its hosts including humans and various domesticated animals. It is believed that bedbug infestations are becoming more problematic now at least in part because long acting, residual insecticides are no longer being used to keep bedbug populations in check. In addition, increased international travel and insecticide resistance have made bedbug infestations spread and made control with insecticides very difficult. In terms of scale, such infestations are of particular concern for hoteliers, cruise ships, trains, daycare facilities, and the like because of the business reputation risk posed by bad press or bad reviews. Other problematic areas tend to include nursing homes, barracks, dorms, hospitals, and various other forms of high density housing. Nonetheless, single family homes can likewise be impacted adversely.

Further, ticks feed on mammalian blood, including human blood. Several serious diseases are transmitted by ticks including, for example, anaplasmosis, Colorado tick fever, tularemia, and Rocky Mountain spotted fever. A prevalent tickborne disease in the United States is Lyme disease. Lyme disease is caused by the bacterium Borrelia burgdorferi and is transmitted to humans through the bite of infected blacklegged ticks.

Pyrethroid, carbamate and organophosphate pesticides are commonly used against biting arthropods. Safety questions have been raised concerning the use of certain of these pesticides, and some governments have restricted the amount of the active component that may be employed in formulations. This itself presents a further problem since the efficacy of certain of these pesticides declines over time and therefore they need to be formulated at higher than effective dosages in order to maintain their effectiveness. Furthermore, some biting arthropods have developed resistance to certain of these pesticides due to their wide spread usage. Also, certain of these pesticides are relatively expensive.

Consumer research regarding the key attributes of arthropod toxicants strongly suggests that consumers prefer products with high efficacy, long-lasting protection, and safety in use. Leading arthropod toxicant products currently available to consumers claim to meet these requirements but almost always disappoint the user for having one or more unacceptable properties. Thus, there is a need to provide biting arthropod toxicant products, especially insect and arachnid toxicant products, which meet the preferences of consumers.

In particular, there is a need to provide a biting arthropod toxicant formulation, especially a mosquito, bed bug, tick, or other arthropod toxicant formulation, which minimizes exposure of toxicants to the people, plants, and other animals which may be exposed to areas of application. A further need is for a biting arthropod toxicant formulation, especially a mosquito, bed bug, tick, or other arthropod toxicant formulation, that overcomes or minimizes resistance to conventional pesticides and provides long lasting effects, thereby limiting the need for frequent re-application to treated areas.

A yet further need is for a biting arthropod toxicant formulation that is safe for humans, animals and the environment that can be used to kill mosquitoes, bed bugs, and ticks, and for safe and effective means to employ such chemicals.

The present disclosure provides many advantages, which shall become apparent as described below.

### SUMMARY OF THE DISCLOSURE

In accordance with this disclosure, killing one or more biting arthropods selected from the group consisting of mosquitoes, bed bugs and ticks is obtained by bringing the biting arthropods into contact with a toxic amount of a formulation comprising:

one or more compounds of structure (I), wherein the compounds of structure (I) comprise:

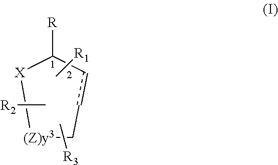

wherein

R is selected from the group consisting of —OH, ═O, —OC(O)R₄, —OR₆, —(OR₆)₂, wherein each R₆ is independently selected from an alkyl group containing from 1 to 4 carbon atoms and R is a branched or straight chain, saturated or unsaturated hydrocarbyl group with zero to two double bonds and from 1 to 15 carbon atoms:

X is O or CH₂, with the proviso that when X is O, then R can only be ═O;

each Z is independently selected from the group consisting of (CH) and (CH₂):

y is a numeral selected from 1 and 2;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms:

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

Also, in accordance with this disclosure, killing mosquitoes is obtained by bringing the mosquitoes into contact with a toxic amount of a formulation comprising:

one or more compounds of structure (I), wherein the compounds of structure (I) comprise:

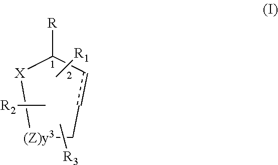

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;

X is O or CH₂, with the proviso that when X is O, then R can only be ═O:

each Z is independently selected from the group consisting of (CH) and (CH₂):

y is a numeral selected from 1 and 2;

R₁ is selected from the group consisting of H or a branched or straight chain, saturated or unsaturated hydrocarbyl group with zero to two double bonds and from 1 to 15 carbon atoms:

R₂ is selected from the group consisting of H and a branched or straight chain, saturated or unsaturated hydrocarbyl group with zero to three double bonds and from 1 to 15 carbon atoms;

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

Further, in accordance with this disclosure, killing bed bugs is obtained by bringing the bed bugs into contact with a toxic amount of a formulation comprising:

one or more compounds of structure (I), wherein the compounds of structure (I) comprise:

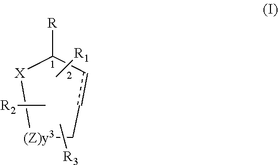

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;

X is O or CH₂, with the proviso that when X is O, then R can only be ═O:

each Z is independently selected from the group consisting of (CH) and (CH₂);

y is a numeral of 1 when X is CH₂, or y is a numeral selected from 1 and 2 when R is ═O and X is O;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms;

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (1) contain from 11 to 20 total carbon atoms.

Still further, in accordance with this disclosure, killing ticks is obtained by bringing the ticks into contact with a toxic amount of a formulation comprising:

one or more compounds of structure (I), wherein the compounds of structure (I) comprise:

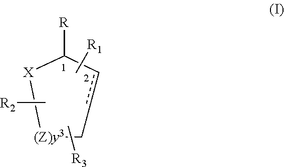

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms:

X is O or CH₂, with the proviso that when X is O, then R can only be ═O;

each Z is independently selected from the group consisting of (CH) and (CH₂):

y is a numeral selected from 1 and 2;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms:

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (1) contain from 11 to 20 total carbon atoms.

This disclosure also includes optical isomers, diastereomers and enantiomers of the named structures. Thus, at all stereocenters where stereochemistry is not explicitly defined, all possible epimers are envisioned. As an aspect of this disclosure, the killing of the biting arthropods may be by way of the compounds being toxic to the biting arthropods and immatures thereof.

Further objects, features and advantages of the present disclosure will be understood by reference to the following detailed description.

### BRIEF DESCRIPTION OF THE DRAWINGS

FIG. 1 shows percent mortality for Aedes aegypti 3-5 d females with Deltamethrin, gamma methyl tridecalactone, delta dodecalactone, and 3M-5H-2cyclohexenone using protocols in accordance with the Examples.

FIG. 2 shows percent mortality for Aedes aegypti 3-5 d females with methyl dihydrojasmonate, gamma methyl tridecalactone and delta dodecalactone using protocols in accordance with the Examples.

### DESCRIPTION OF THE EMBODIMENTS

Killing one or more biting arthropods selected from the group consisting of mosquitoes, bed bugs and ticks is accomplished by bringing the biting arthropods into contact with a toxic amount of a formulation comprising:

(1) one or more compounds of structure (I), wherein the compounds of structure (I) comprise:

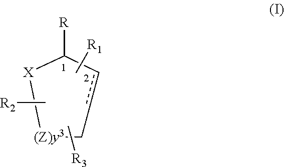

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms:

X is O or CH₂, with the proviso that when X is O, then R can only be ═O;

each Z is independently selected from the group consisting of (CH) and (CH₂):

y is a numeral selected from 1 and 2;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms:

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

A preferred group of biting insect, arachnid or other arthropod toxicant compounds are those compounds of structure (I) wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

A further preferred group of biting insect, arachnid or other arthropod toxicant compounds are those compounds of structure (I) wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₃ is an alkyl or alkenyl group containing at least 3 carbon atoms.

Another preferred group of biting insect, arachnid or other arthropod toxicant compounds are those compounds of structure (I) wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

An especially preferred group of biting insect, arachnid or other arthropod toxicant agents of structure (I) include methyl jasmonate, methyl dihydrojasmonate, ethyl dihydrojasmonate, propyl dihydrojasmonate, methyl dihydrojasmolate (methyl 2-(3-hydroxy-2-pentylcyclopentyl)acetate), apritone (cyclopentanone, 2-(3,7-dimethyl-2,6-octadienvyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone.

Representative examples of compounds of structure (I) include, but are not limited to,

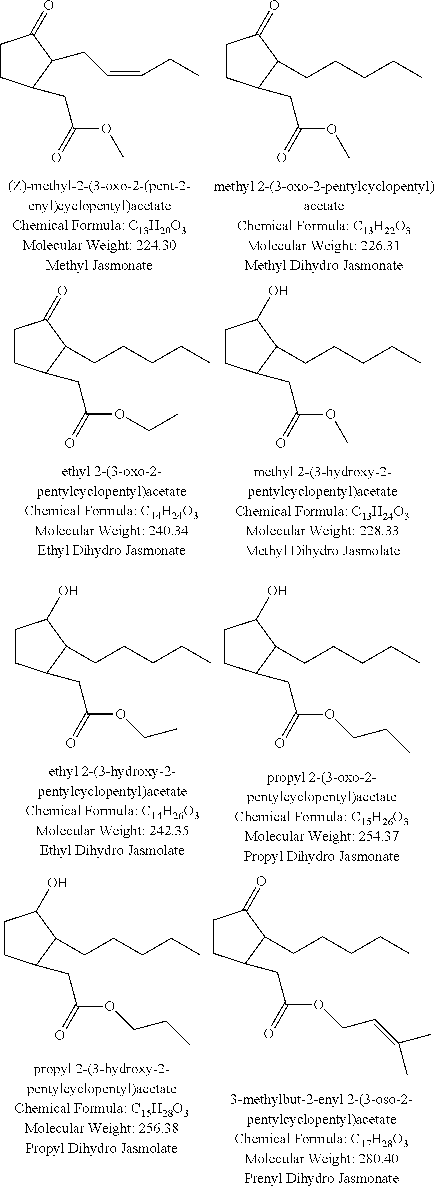

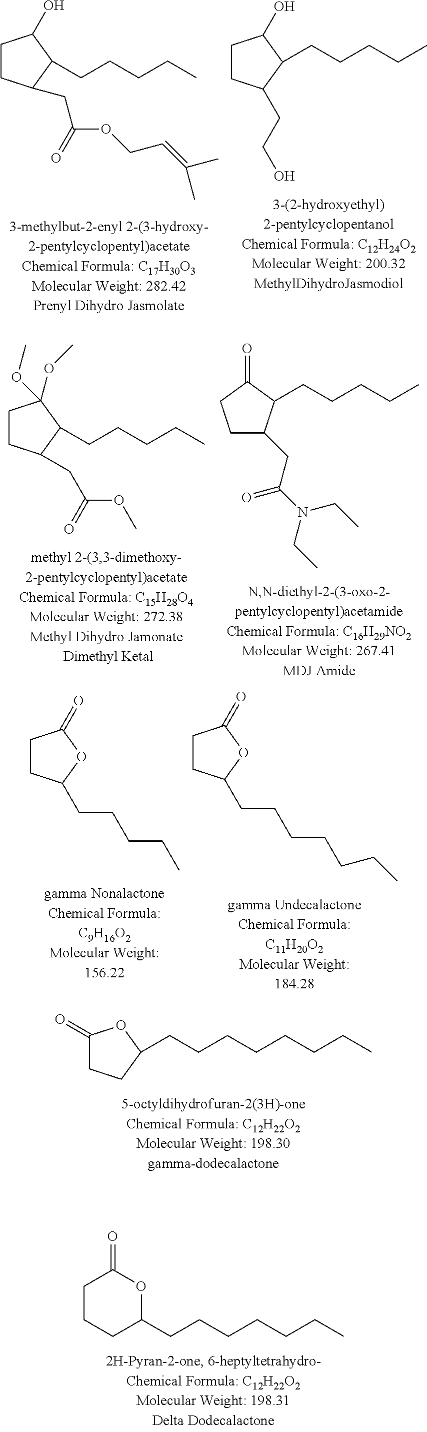

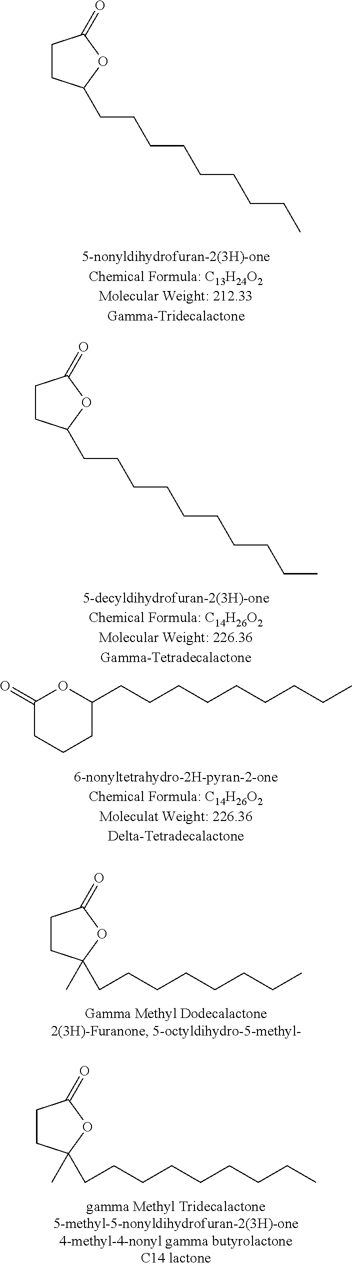 [SMILES: CCCCCCCCCC1CCC(=O)O1 ; CCCCCCCCCCC1CCC(=O)O1 ; CCCCCCCCCC1CCCC(=O)O1 ; CCCCCCCCC1(C)CCC(=O)O1 ; CCCCCCCCCC1(C)CCC(=O)O1]

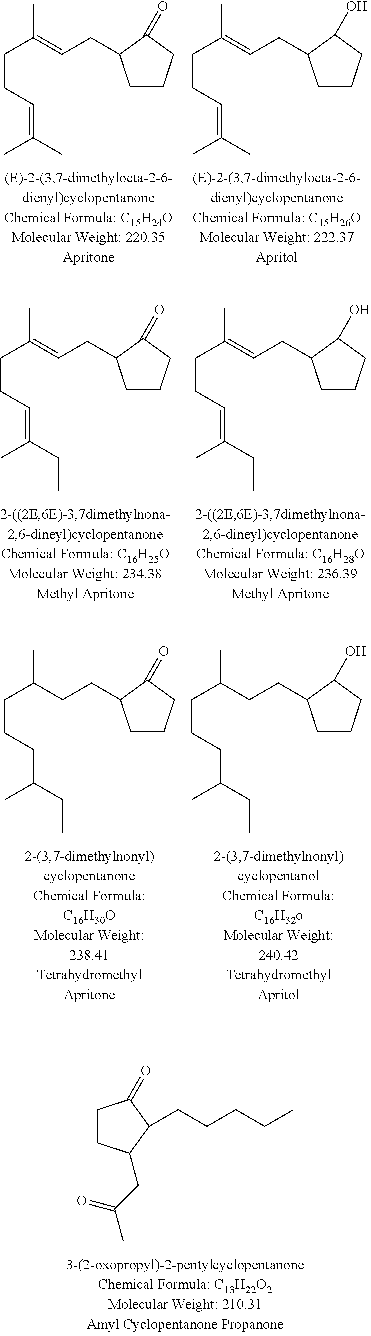

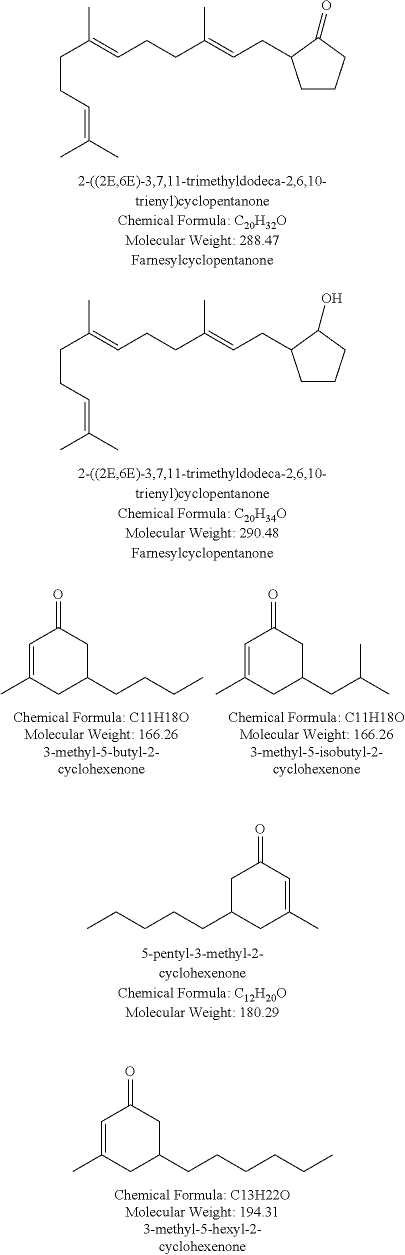

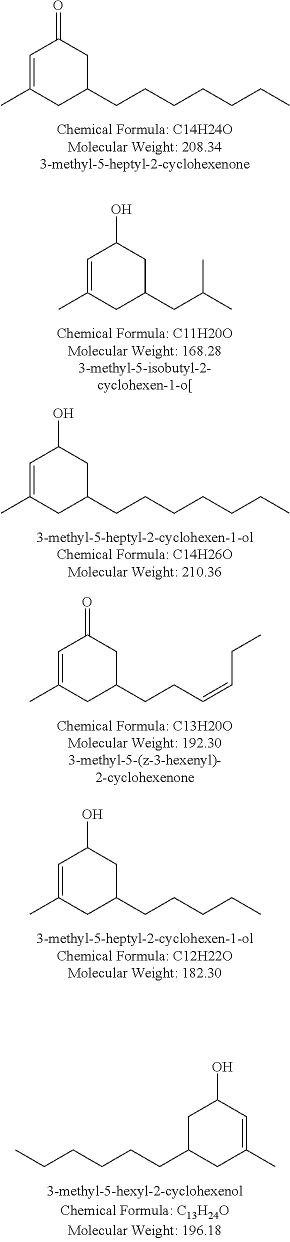

In an embodiment, killing mosquitoes is accomplished by bringing the mosquitoes into contact with a toxic amount of a formulation comprising:

one or more compounds of structure (I), wherein the compounds of structure (I) comprise:

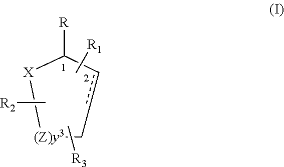

wherein

R is selected from the group consisting of —OH, ═O, —OC(O)R₄, —OR₆, —(OR₆)₂, wherein each R₆ is independently selected from an alkyl group containing from 1 to 4 carbon atoms and R is a branched or straight chain, saturated or unsaturated hydrocarbyl group with zero to two double bonds and from 1 to 15 carbon atoms:

X is O or CH₂, with the proviso that when X is O, then R can only be ═O;

each Z is independently selected from the group consisting of (CH) and (CH₂):

y is a numeral selected from 1 and 2;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms:

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

An especially preferred group of mosquito toxicant agents of structure (I) include methyl jasmonate, methyl dihydrojasmonate, methyl dihydrojasmolate, ethyl dihydrojasmonate, and delta dodecalactone.

In another embodiment, killing bed bugs is accomplished by bringing the bed bugs into contact with a toxic amount of a formulation comprising:

one or more compounds of structure (I), wherein the compounds of structure (I) comprise:

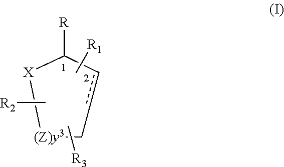

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;

X is O or CH₂, with the proviso that when X is O, then R can only be ═O;

each Z is independently selected from the group consisting of (CH) and (CH₂);

y is a numeral of 1 when X is CH₂, or y is a numeral selected from 1 and 2 when R is ═O and X is O;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms;

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

A preferred group of bed bug toxicant compounds are those compounds of structure (I) wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

A further preferred group of bed bug toxicant compounds are those compounds of structure (1) wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

Another preferred group of bed bug toxicant compounds are those compounds of structure (1) wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

An especially preferred group of bed bug toxicant agents of structure (I) include methyl jasmonate, methyl dihydrojasmonate, ethyl dihydrojasmonate, propyl dihydrojasmonate, methyl dihydrojasmolate (methyl 2-(3-hydroxy-2-pentylcyclopentyl)acetate), apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, or gamma-tetradecalactone.

In still another embodiment, killing ticks is accomplished by bringing the ticks into contact with a toxic amount of a formulation comprising:

one or more compounds of structure (I), wherein the compounds of structure (1) comprise:

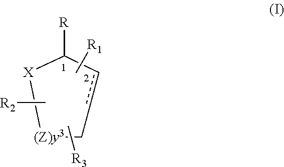

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;

X is O or CH₂, with the proviso that when X is O, then R can only be ═O;

each Z is independently selected from the group consisting of (CH) and (CH₂);

y is a numeral selected from 1 and 2;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms:

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

A preferred group of tick toxicant compounds are those compounds of structure (1) wherein R is ═O or —OH, X is CH₂, Z is (CH) or (CH₂), y is 1, the bond between positions 2 and 3 is a single bond. R₁ is H, R₂ is H, and R₃ is an alkenyl group having at least 11 carbon atoms and 1 or 2 double bonds.

A further preferred group of tick toxicant compounds are those compounds of structure (1) wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₃ is an alkyl or alkenyl group containing at least 3 carbon atoms.

Another preferred group of tick compounds are those compounds of structure (I) wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

An especially preferred group of tick toxicant agents of structure (I) include methyl jasmonate, methyl dihydrojasmonate, ethyl dihydrojasmonate, propyl dihydrojasmonate, methyl dihydrojasmolate (methyl 2-(3-hydroxy-2-pentylcyclopentyl)acetate), apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone.

The active compounds of structure (I) may be formulated into any suitable formulations such as for example, including but not limited to, solutions, oils, creams, lotions, shampoos, aerosols or the like. Traditional inert carriers such as, including but not limited to, alcohols, esters and petroleum distillates, could be used to produce formulations of the active compounds to be used as toxicant formulations. Another series of carriers are the biodegradable oils, including but not limited to, the Olestra® family of oils, isopropyl myristate and squalane.

When the formulation will be used as an aerosol, it is preferable to add a propellant. Suitable propellants include propane, butane, isobutane, dimethyl ether, carbon dioxide, nitrous oxide, nitrogen, and combinations thereof.

The amount of the formulation will depend upon the type of formulation used and the particular biting insect, arachnid or other arthropod against which the formulation is employed, but will generally range from about 0.00001% to about 50% by weight, from about 0.0001% to about 30% by weight, or from about 0.001% to about 25% by weight, or from about 0.01% to about 20% by weight, or from about 0.01% to about 15% by weight, or from about 0.01% to about 10% by weight, or from about 0.01% to about 5% by weight, in a carrier.

The formulation may be applied to surfaces of, or impregnated in, clothing or fabric. The formulation may be applied to fabrics such as, but not limited to mosquito nets. The amount of active material can be about 0.0125 g/ft to about 15 g/ft², or about 0.015 g/ft² to about 14 g/ft², or about 0.015 g/ft² to about 12 g/ft², or about 0.015 g/ft² to about 10 g/ft², or about 0.015 g/ft² to about 8 g/ft², or about 0.015 g/ft² to about 6 g/ft², or about 0.015 g/ft² to about 5 g/ft², or about 0.015 g/ft² to about 4 g/ft², or about 0.015 g/ft² to about 2 g/ft², or about 0.015 g/ft² to about 1 g/ft².

The formulation may be applied to outdoor materials such as, but not limited to, lawns, trees, shrubbery, or flooring to prevent the biting arthropods from resting there. Also, the formulation may be applied to indoor materials or fabrics such as, but not limited to bed nets or mosquito nets. For outdoor and indoor surfaces, the amount of active material can be about 0.125 g/m² to about 150 g/m², or about 0.125 g/m² to about 140 g/m², or about 0.125 g/m² to about 130 g/m², or about 0.125 g/m² to about 120 g/m², or about 0.125 g/m² to about 110 g/m², or about 0.125 g/m² to about 100 g/m², or about 0.125 g/m² to about 90 g/m², or about 0.125 g/m² to about 80 g/m², or about 0.125 g/m² to about 70 g/m², or about 0.125 g/m² to about 60 g/m², or about 0.125 g/m² to about 50 g/m², or about 0.125 g/m² to about 40 g/m², or about 0.125 g/m² to about 30 g/m², or about 0.125 g/m² to about 25 g/m², or about 0.125 g/m² to about 20 g/m², or about 0.125 g/m² to about 15 g/m², or about 0.125 g/m² to about 10 g/m², or about 0.125 g/m² to about 5 g/m².

The formulation may also be applied to outdoor materials such as, but not limited to, lawns, trees, shrubbery, or flooring to prevent the biting arthropods from resting there.

For bed bugs and other biting arthropods, the formulation may be employed by various methods including, for example, (1) injecting or spraying the formulations into or onto a mattress, either directly or in combination with other ingredients or solvents, (2) placing the formulations on an absorbent material and placing the absorbent material in a sachet and placing the sachet containing the formulation into a locus such as, including but not limited to, a mattress, hamper, suitcase, clothing bag, linen storage closet or any other enclosure where bed bugs may be present, (3) preparing “dryer sheets” containing the formulations for placement in a locus such as, including but not limited to, a mattress, suitcase, clothing bag, hamper, clothing bag, linen storage closet, or any other enclosure where bed bugs are likely to be present, or in a pile of clean or soiled laundry. (4) placing the formulation into detergent or fabric softener compositions for killing of bed bugs and other arthropods during use of these compositions in cleaning clothes and sprays or in carpet or floor cleaner products and the like to treat carpets and furniture, and (5) spraying a formulation on surfaces, luggage, furniture, into crevices, or behind fixtures.

The formulations described above can be prepared by any convenient means, e.g., by mixing the active compound or active compounds with one or more other carriers or vehicles such as, including but not limited to, those described herein before.

Preferred embodiments of this disclosure are set forth in the clauses below.

1. A method for killing mosquitoes, the method comprising bringing the mosquitoes into contact with a toxic amount of a formulation comprising:

one or more compounds of structure (1), wherein the compounds of structure (I) comprise:

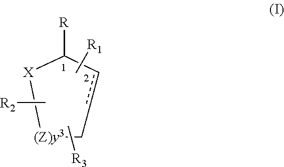

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;

X is O or CH₂, with the proviso that when X is O, then R can only be ═O:

each Z is independently selected from the group consisting of (CH) and (CH₂);

y is a numeral selected from 1 and 2;

R₁ is selected from the group consisting of H or a branched or straight chain, saturated or unsaturated hydrocarbyl group with zero to two double bonds and from 1 to 15 carbon atoms:

R₂ is selected from the group consisting of H and a branched or straight chain, saturated or unsaturated hydrocarbyl group with zero to three double bonds and from 1 to 15 carbon atoms;

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

2. The method according to clause 1 wherein the one or more compounds of structure (1) are selected from the group consisting of methyl jasmonate, methyl dihydrojasmonate, methyl dihydrojasmolate (methyl 2-(3-hydroxy-2-pentylcyclopentyl)acetate), ethyl dihydrojasmonate, and delta dodecalactone.

3. The method according to clause 1 wherein the formulation is applied to a surface of or impregnated into clothing of fabric.

4. The method according to clause 1 wherein the formulation is applied to detergents, fabric softeners, or dryer sheets.

5. The method according to clause 1 wherein the formulation is applied to furniture, building supplies, electronic devices, cargo, or storage areas.

6. The method according to clause 1 wherein the formulation is toxic to immature mosquitoes.

7. The method according to clause 1 wherein the formulation is present in an amount from about 0.00001% to about 50% by weight, in a carrier.

8. The method according to clause 1 wherein the formulation is applied to a surface of, or impregnated in, clothing or fabric, such that the amount of active material is about 0.0125 g/ft² to about 15 g/ft², or wherein the formulation is applied to an outdoor or indoor surface such that the amount of active material is about 0.125 g/m² to about 150 g/m².

9. A method for killing bed bugs, the method comprising bringing the bed bugs into contact with a toxic amount of a formulation comprising:

one or more compounds of structure (1), wherein the compounds of structure (I) comprise:

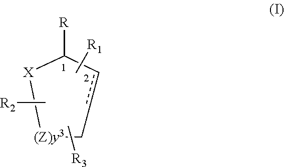

wherein

R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms:

X is O or CH₂, with the proviso that when X is O, then R can only be ═O:

each Z is independently selected from the group consisting of (CH) and (CH₂):

y is a numeral of 1 when X is CH₂, or y is a numeral selected from 1 and 2 when R is ═O and X is O;

R₁ is selected from the group consisting of H or a branched or straight chain, saturated or unsaturated hydrocarbyl group with zero to two double bonds and from 1 to 15 carbon atoms:

R₂ is selected from the group consisting of H and a branched or straight chain, saturated or unsaturated hydrocarbyl group with zero to three double bonds and from 1 to 15 carbon atoms;

R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;

the bond between the 2 and 3 positions in the ring structure may be a single or a double bond; and

wherein the compounds of structure (I) contain from 11 to 20 total carbon atoms.

10. The method according to clause 9 wherein the one or more compounds of structure (I) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

11. The method according to clause 9 wherein the one or more compounds of structure (I) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

12. The method of clause 9 wherein the one or more compounds of structure (I) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

13. The method according to clause 9 wherein the one or more compounds of structure (1) are selected from the group consisting of

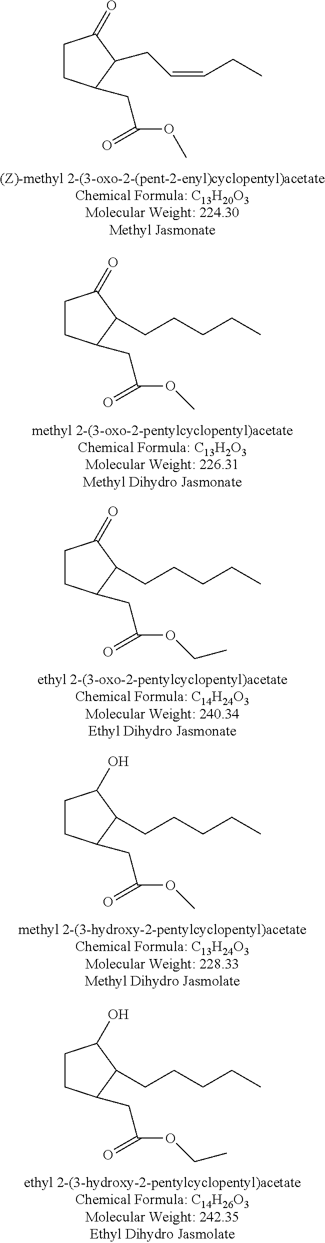 [SMILES: CC/C=C\CC1C(=O)CCC1CC(=O)OC ; CCCCCC1C(=O)CCC1CC(=O)OC ; CCCCCC1C(=O)CCC1CC(=O)OCC ; CCCCCC1C(O)CCC1CC(=O)OC ; CCCCCC1C(O)CCC1CC(=O)OCC]

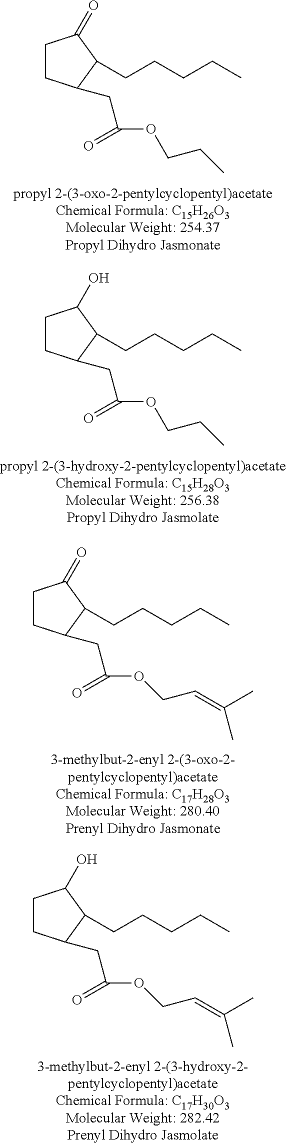 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

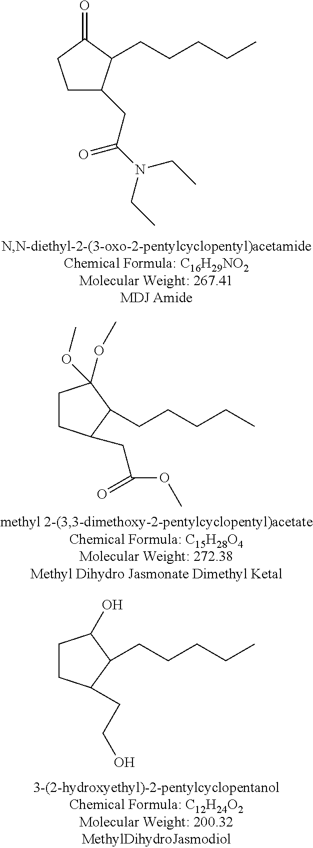 [SMILES: CCCCCC1C(=O)CCC1CC(=O)N(CC)CC ; CCCCCC1C(CC(=O)OC)CCC1(OC)OC ; CCCCCC1C(O)CCC1CCO]

14. The method according to clause 9 wherein the one or more compounds of structure (1) are selected from the group consisting of:

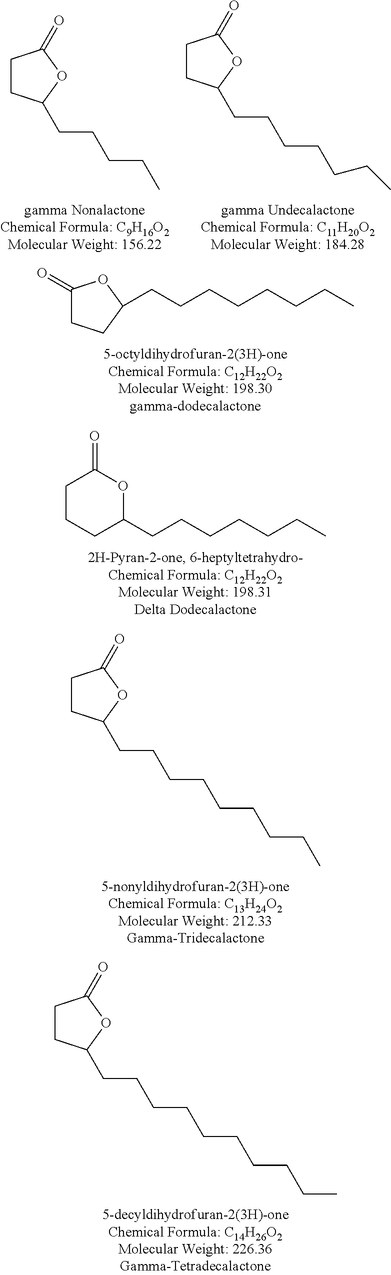 [SMILES: CCCCCC1CCC(=O)O1 ; CCCCCCCC1CCC(=O)O1 ; CCCCCCCCC1CCC(=O)O1 ; CCCCCCCC1CCCC(=O)O1 ; CCCCCCCCCC1CCC(=O)O1 ; CCCCCCCCCCC1CCC(=O)O1]

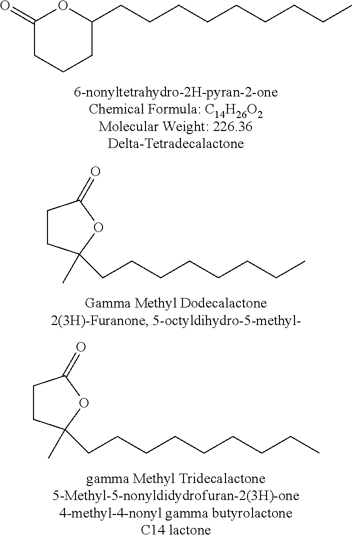 [SMILES: CCCCCCCCCC1CCCC(=O)O1 ; CCCCCCCCC1(C)CCC(=O)O1 ; CCCCCCCCCC1(C)CCC(=O)O1]

15. The method according to clause 9 wherein the one or more compounds of structure (I) are selected from the group consisting of

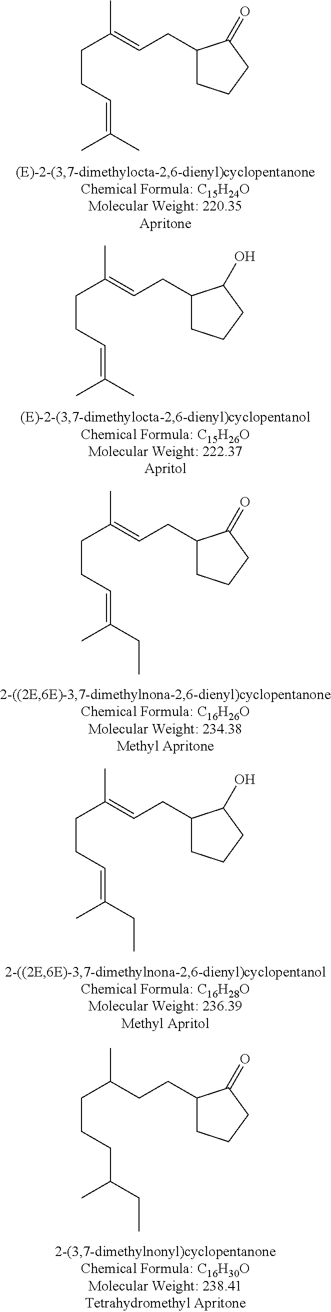 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O]

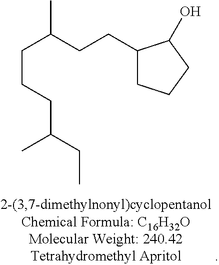 [SMILES: CCC(C)CCCC(C)CCC1CCCC1O]

16. The method according to clause 9 wherein the one or more compounds of structure (I) are selected from the group consisting of:

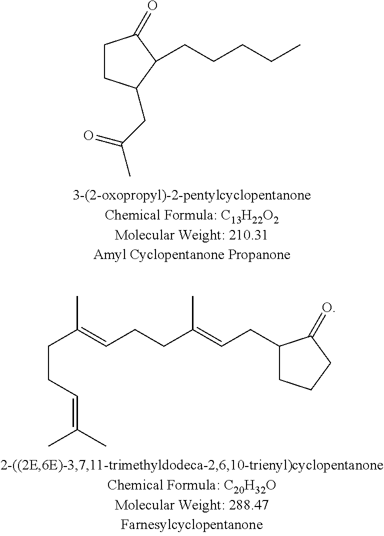 [SMILES: CCCCCC1C(=O)CCC1CC(C)=O ; CC(C)=CCC/C(C)=C/CC/C(C)=C/CC1CCCC1=O]

17. The method according to clause 9 wherein the formulation is applied to a surface of or impregnated into clothing of fabric.

18. The method according to clause 9 wherein the formulation is applied to detergents, fabric softeners, or dryer sheets.

19. The method according to clause 9 wherein the formulation is applied to furniture, building supplies, electronic devices, cargo, or storage areas.

20. The method according to clause 9 wherein the biting arthropod is brought into contact with the formulation comprising one or more of the compounds of structure (I) comprising methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, or delta dodecalactone.

21. The method according to clause 9 wherein the one or more compounds of structure (I) comprise methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, or gamma-tetradecalactone.

22. The method according to clause wherein the one compounds of structure (I) comprise methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone, or methyl apritone.

23. The method according to clause 9 wherein the formulation is toxic to immature bed bugs.

24. The method according to clause 9 wherein the formulation is present in an amount from about 0.00001% to about 50% by weight, in a carrier.

25. The method according to clause 9 wherein the formulation is applied to a surface of, or impregnated in, clothing or fabric, such that the amount of active material is about 0.0125 g/ft² to about 15 g/ft², or wherein the formulation is applied to an outdoor or indoor surface such that the amount of active material is about 0.125 g/m² to about 150 g/m².

26. A method for killing ticks, the method comprising bringing the ticks into contact with a toxic amount of a formulation comprising:

one or more compounds of structure (I), wherein the compounds of structure (1) comprise:

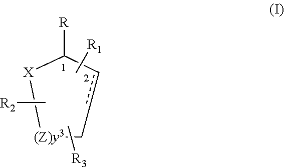

wherein

R is selected from the group consisting of —OH, ═O, —OC(O)R₄, —OR₆, —(OR)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;

X is O or CH₂, with the proviso that when X is O, then R can only be ═O;

each Z is independently selected from the group consisting of (CH) and (CH₂);

y is a numeral selected from 1 and 2;

R₁ is selected from the group consisting of H or a branched or straight chain, saturated or unsaturated hydrocarbyl group with zero to two double bonds and from 1 to 15 carbon atoms;

R₂ is selected from the group consisting of H and a branched or straight chain, saturated or unsaturated hydrocarbyl group with zero to three double bonds and from 1 to 15 carbon atoms;

R₃ is selected from the group consisting of H and a branched or straight chain, saturated or unsaturated hydrocarbyl group with zero to three double bonds and from 1 to 15 carbon atoms, —(CH₂)OH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12:

the bond between the 2 and 3 positions in the ring structure may be a single or a double bond; and

wherein the compounds of structure (1) contain from 11 to 20 total carbon atoms.

27. The method according to clause 26 wherein the one or more compounds of structure (I) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

28. The method according to clause 26 wherein the one or more compounds of structure (1) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

29. The method of clause 26 wherein the one or more compounds of structure (I) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

30. The method according to clause 26 wherein the one or more compounds of structure (I) are selected from the group consisting of

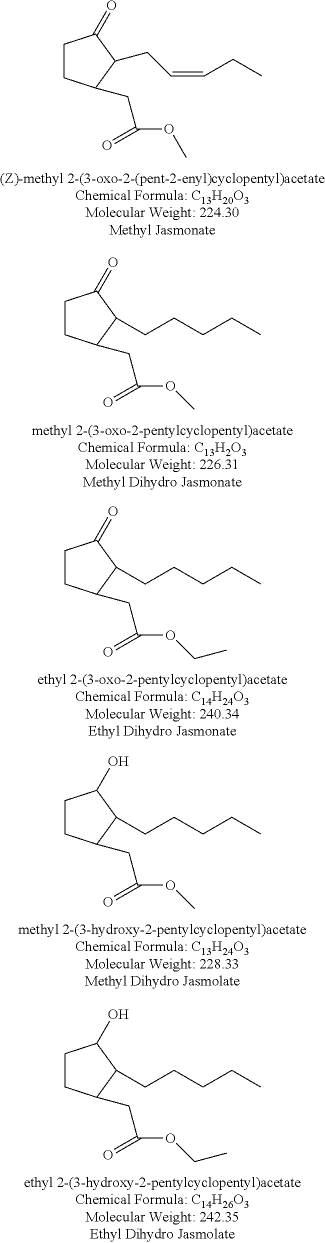 [SMILES: CC/C=C\CC1C(=O)CCC1CC(=O)OC ; CCCCCC1C(=O)CCC1CC(=O)OC ; CCCCCC1C(=O)CCC1CC(=O)OCC ; CCCCCC1C(O)CCC1CC(=O)OC ; CCCCCC1C(O)CCC1CC(=O)OCC]

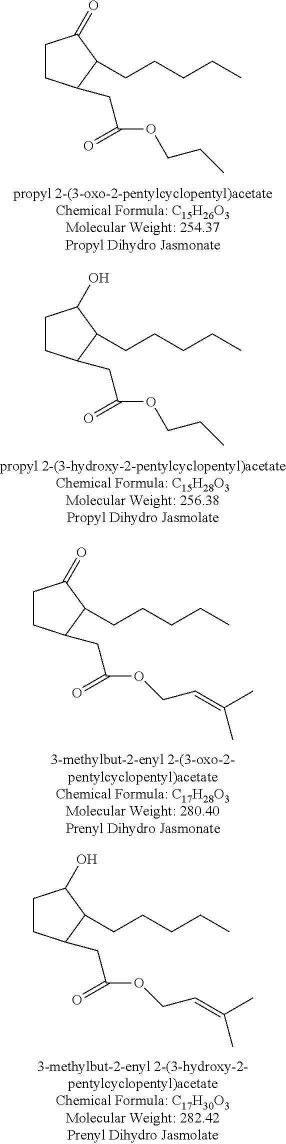 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

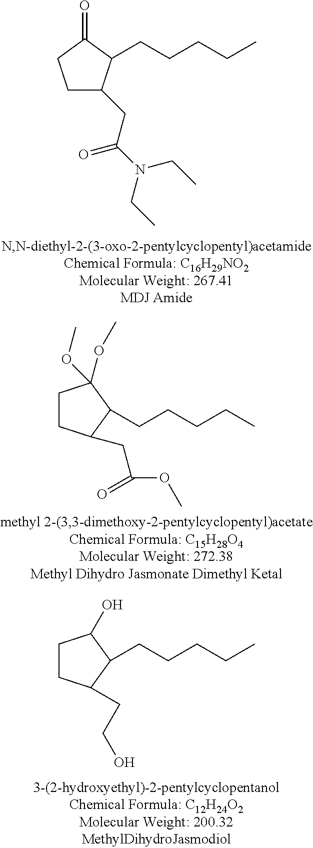 [SMILES: CCCCCC1C(=O)CCC1CC(=O)N(CC)CC ; CCCCCC1C(CC(=O)OC)CCC1(OC)OC ; CCCCCC1C(O)CCC1CCO]

31. The method according to clause 26 wherein the one or more compounds of structure (1) are selected from the group consisting of:

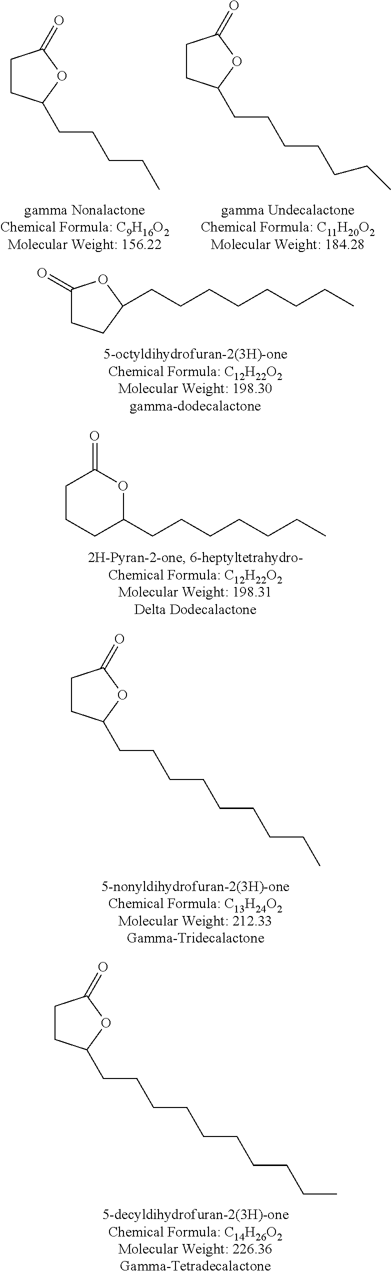 [SMILES: CCCCCC1CCC(=O)O1 ; CCCCCCCC1CCC(=O)O1 ; CCCCCCCCC1CCC(=O)O1 ; CCCCCCCC1CCCC(=O)O1 ; CCCCCCCCCC1CCC(=O)O1 ; CCCCCCCCCCC1CCC(=O)O1]

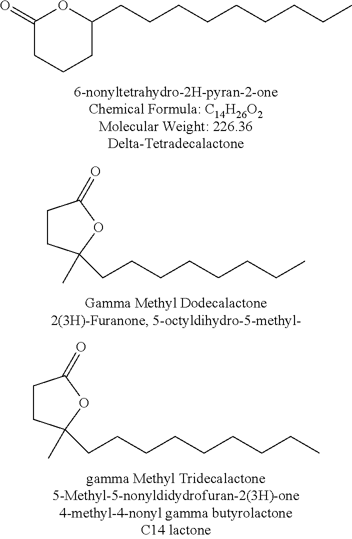 [SMILES: CCCCCCCCCC1CCCC(=O)O1 ; CCCCCCCCC1(C)CCC(=O)O1 ; CCCCCCCCCC1(C)CCC(=O)O1]

32. The method according to clause 26 wherein the one or more compounds of structure (I) are selected from the group consisting of

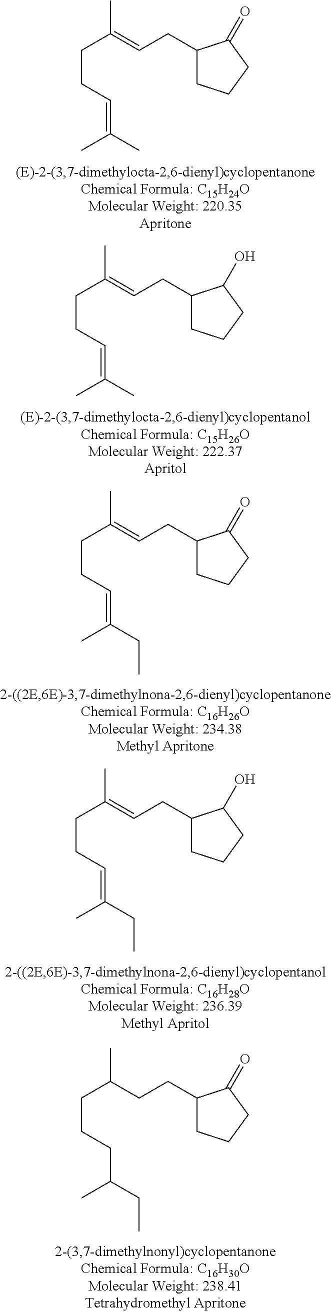 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O]

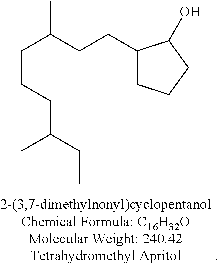 [SMILES: CCC(C)CCCC(C)CCC1CCCC1O]

33. The method according to clause 26 wherein the one or more compounds of structure (I) are selected from the group consisting of:

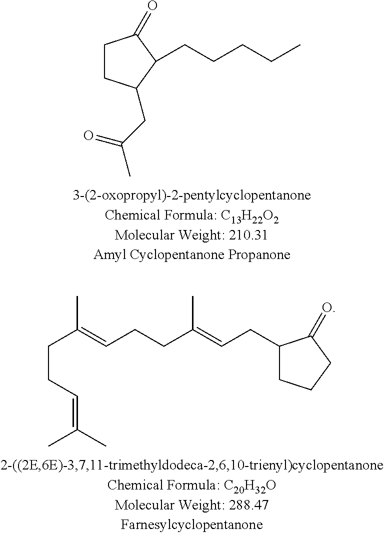 [SMILES: CCCCCC1C(=O)CCC1CC(C)=O ; CC(C)=CCC/C(C)=C/CC/C(C)=C/CC1CCCC1=O]

34. The method according to clause 26 wherein the one or more compounds of structure (1) are selected from the group consisting of

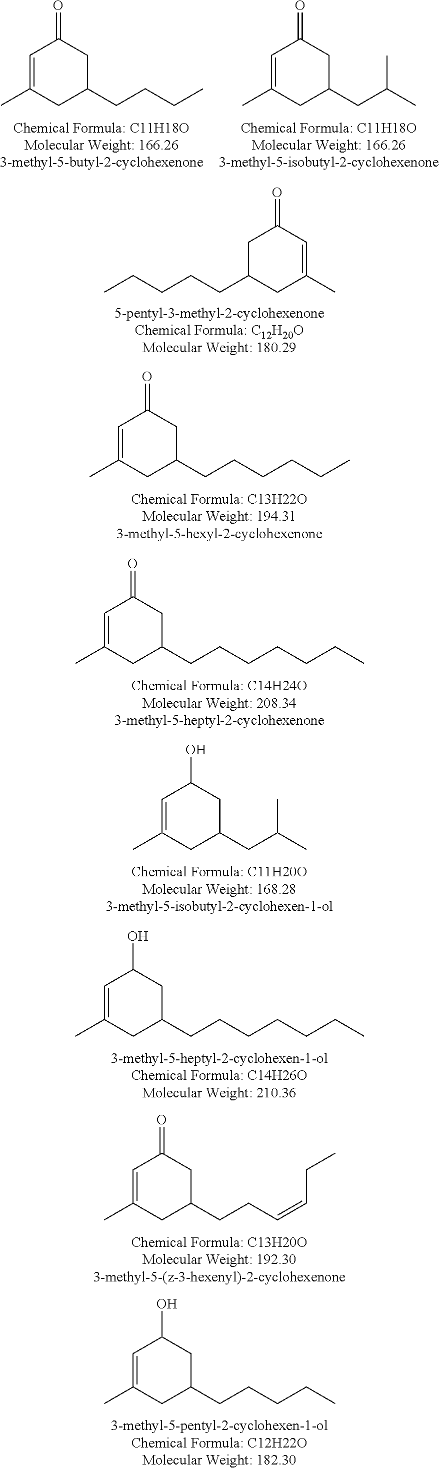

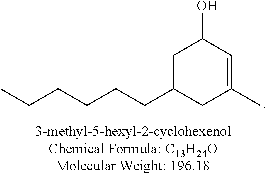

35. The method according to clause 26 wherein the formulation is applied to a surface of or impregnated into clothing of fabric.

36. The method according to clause 26 wherein the formulation is applied to detergents, fabric softeners, or dryer sheets.

37. The method according to clause 26 wherein the formulation is applied to furniture, building supplies, electronic devices, cargo, or storage areas.

38. The method according to clause 26 wherein the biting arthropod is brought into contact with the formulation comprising one or more of the compounds of structure (1) comprising methyl jasmonate, methyl dihydrojasmonate, methyl dihydrojasmolate, ethyl dihydrojasmonate, propyl dihydrojasmonate, or delta dodecalactone.

39. The method according to clause 26 wherein the one or more compounds of structure (I) comprise methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone.

40. The method according to clause 26 wherein the one compounds of structure (I) comprise methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone, methyl apritone, or 3-methyl-5-hexyl-2-cyclohexenone.

41. The method according to clause 26 wherein the formulation is toxic to immature ticks.

42. The method according to clause 26 wherein the formulation is present in an amount from about 0.00001% to about 50% by weight, in a carrier.

43. The method according to clause 26 wherein the formulation is applied to a surface of, or impregnated in, clothing or fabric, such that the amount of active material is about 0.0125 g/ft² to about 15 g/ft², or wherein the formulation is applied to an outdoor or indoor surface such that the amount of active material is about 0.125 g/m² to about 150 g/m².

### EXAMPLES

Protocols for mosquito toxicity assessment of compounds used in the Examples are set forth below.

### CDC Bottle Assay

Solutions were prepared and the bottles coated according to the CDC protocol. Ten unfed female mosquitoes aged 3-5 days were introduced into four 250 ml Wheaton bottles coated with experimental compound with and without the conventional pyrethroid pesticide (i.e., Deltamethrin) and one control bottle coated with acetone only. The number of dead or alive mosquitoes was monitored at different time intervals (15, 30, 45, 60 minutes). This allowed time to determine the total percent mortality against time for all replicates.

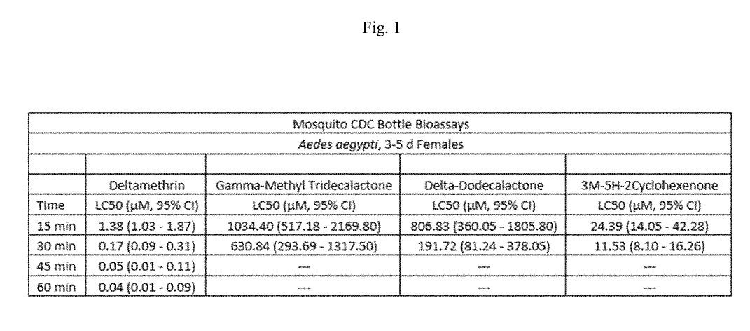

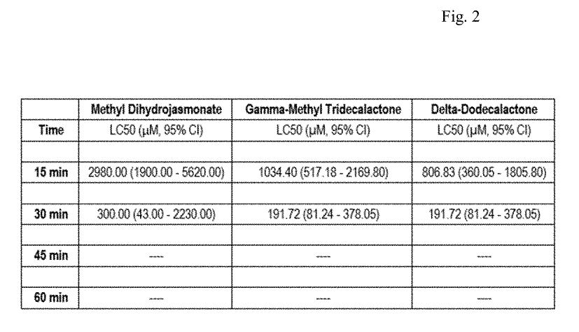

Mosquito CDC bottle bioassays with Deltamethrin and compounds of this disclosure were conducted in accordance with the above protocol. The mosquitoes were Aedes aegypti 3-5 d females. FIG. 1 shows shows percent mortality for Aedes aegypti 3-5 d females with Deltamethrin, gamma methyl tridecalactone, delta dodecalactone, and 3M-5H-2cyclohexenone using the above protocol. FIG. 2 shows percent mortality for Aedes aegypti 3-5 d females with methyl dihydrojasmonate, gamma methyl tridecalactone and delta dodecalactone using above protocol.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for killing mosquitoes, the method comprising bringing the mosquitoes into contact with a toxic amount of a formulation comprising:
one or more compounds of structure (I), wherein the compounds of structure (I) comprise: 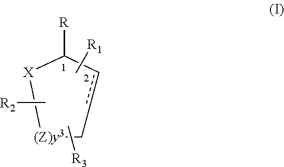
wherein
R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;
X is O or CH₂, with the proviso that when X is O, then R can only be ═O;
each Z is independently selected from the group consisting of (CH) and (CH₂);
y is a numeral selected from 1 and 2;
R₁ is selected from the group consisting of H or a branched or straight chain, saturated or unsaturated hydrocarbyl group with zero to two double bonds and from 1 to 15 carbon atoms;
R₂ is selected from the group consisting of H and a branched or straight chain, saturated or unsaturated hydrocarbyl group with zero to three double bonds and from 1 to 15 carbon atoms;
R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;
the bond between the 2 and 3 positions in the ring structure may be a single or a double bond; and
wherein the compounds of structure (I) contain from 11 to 20 total carbon atoms.

2. The method according to claim 1 wherein the one or more compounds of structure (1) are selected from the group consisting of methyl jasmonate, methyl dihydrojasmonate, methyl dihydrojasmolate (methyl 2-(3-hydroxy-2-pentylcyclopentyl)acetate), ethyl dihydrojasmonate and delta dodecalactone.

3. The method according to claim 1 wherein the formulation is applied to a surface of or impregnated into clothing of fabric; or
wherein the formulation is applied to detergents, fabric softeners, or dryer sheets; or
wherein the formulation is applied to furniture, building supplies, electronic devices, cargo, or storage areas.

4. The method according to claim 1 wherein the formulation is toxic to immature mosquitoes.

5. The method according to claim 1 wherein the formulation is present in an amount from about 0.00001% to about 50% by weight, in a carrier; or
wherein the formulation is applied to a surface of, or impregnated in, clothing or fabric, such that the amount of active material is about 0.0125 g/ft² to about 15 g/ft², or wherein the formulation is applied to an outdoor or indoor surface such that the amount of active material is about 0.125 g/m² to about 150 g/m².

6. A method for killing bed bugs, the method comprising bringing the bed bugs into contact with a toxic amount of a formulation comprising:
one or more compounds of structure (I), wherein the compounds of structure (I) comprise: 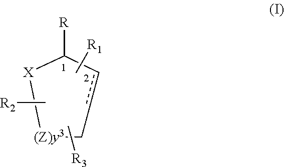
wherein
R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;
X is O or CH₂, with the proviso that when X is O, then R can only be ═O;
each Z is independently selected from the group consisting of (CH) and (CH₂);
y is a numeral of 1 when X is CH₂, or y is a numeral selected from 1 and 2 when R is ═O and X is O;
R₁ is selected from the group consisting of H or a branched or straight chain, saturated or unsaturated hydrocarbyl group with zero to two double bonds and from 1 to 15 carbon atoms;
R₂ is selected from the group consisting of H and a branched or straight chain, saturated or unsaturated hydrocarbyl group with zero to three double bonds and from 1 to 15 carbon atoms;
R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;
the bond between the 2 and 3 positions in the ring structure may be a single or a double bond; and
wherein the compounds of structure (1) contain from 11 to 20 total carbon atoms.

7. The method according to claim 6 wherein the one or more compounds of structure (I) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds; or
wherein the one or more compounds of structure (1) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms; or
wherein the one or more compounds of structure (I) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

8. The method according to claim 6 wherein the one or more compounds of structure (I) are selected from the group consisting of 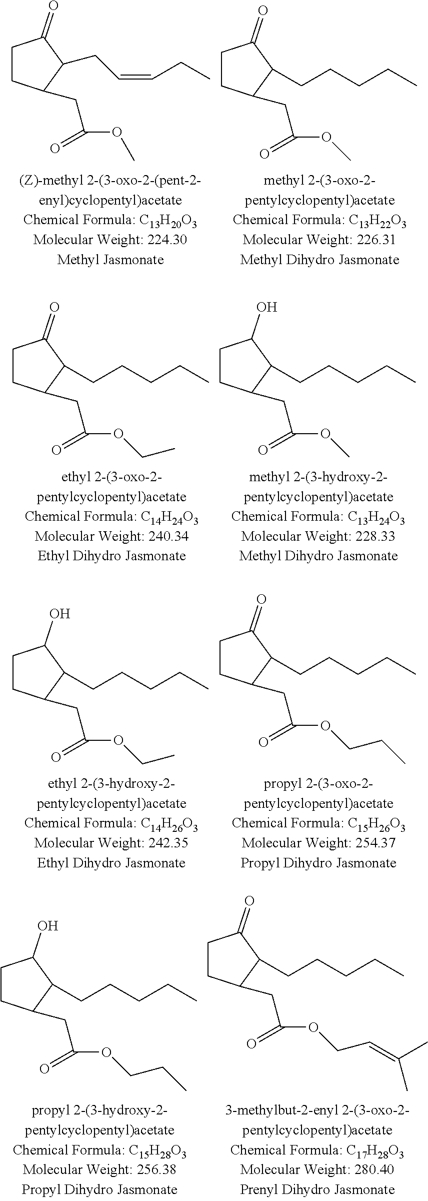 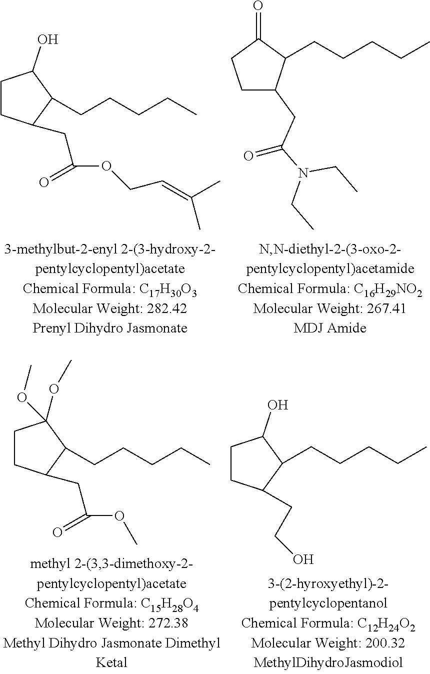
or
wherein the one or more compounds of structure (1) are selected from the group consisting of: 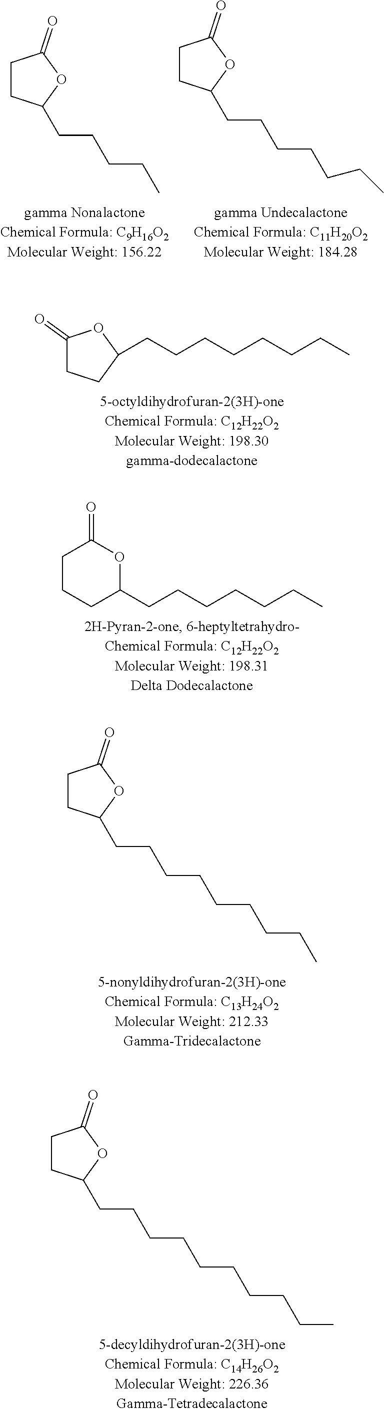 [SMILES: CCCCCC1CCC(=O)O1 ; CCCCCCCC1CCC(=O)O1 ; CCCCCCCCC1CCC(=O)O1 ; CCCCCCCC1CCCC(=O)O1 ; CCCCCCCCCC1CCC(=O)O1 ; CCCCCCCCCCC1CCC(=O)O1] 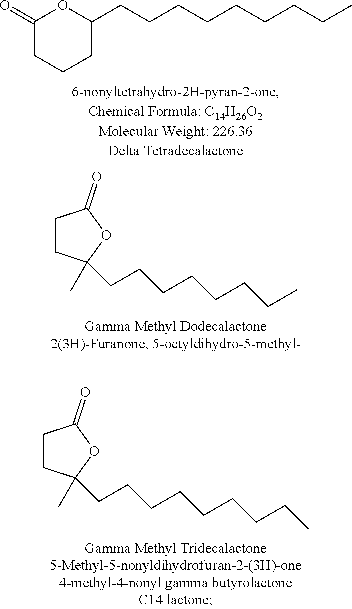 [SMILES: CCCCCCCCCC1CCCC(=O)O1 ; CCCCCCCCC1(C)CCC(=O)O1 ; CCCCCCCCCC1(C)CCC(=O)O1]
or
wherein the one or more compounds of structure (I) are selected from the group consisting of 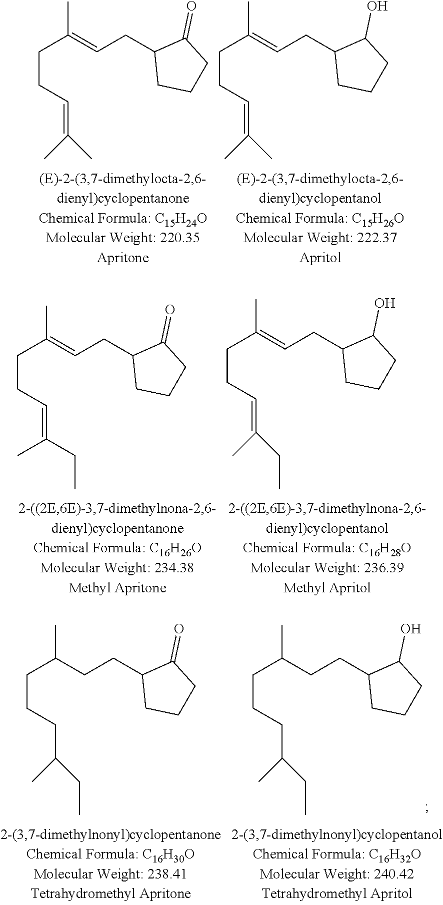
or
wherein the one or more compounds of structure (I) are selected from the group consisting of:

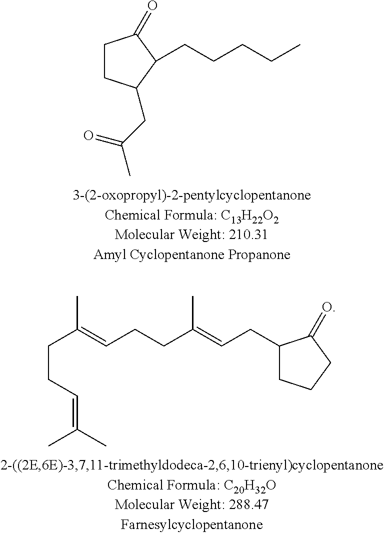 [SMILES: CCCCCC1C(=O)CCC1CC(C)=O ; CC(C)=CCC/C(C)=C/CC/C(C)=C/CC1CCCC1=O]

9. The method according to claim 6 wherein the formulation is applied to a surface of or impregnated into clothing of fabric; or
wherein the formulation is applied to detergents, fabric softeners, or dryer sheets; or
wherein the formulation is applied to furniture, building supplies, electronic devices, cargo, or storage areas.

10. The method according to claim 6 wherein the one or more compounds of structure (I) comprise methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, or gamma-tetradecalactone.

11. The method according to claim 6 wherein the formulation is toxic to immature bed bugs.

12. The method according to claim 6 wherein the formulation is present in an amount from about 0.00001% to about 50% by weight, in a carrier; or
wherein the formulation is applied to a surface of, or impregnated in, clothing or fabric, such that the amount of active material is about 0.0125 g/ft² to about 15 g/ft², or wherein the formulation is applied to an outdoor or indoor surface such that the amount of active material is about 0.125 g/m² to about 150 g/m².

13. A method for killing ticks, the method comprising bringing the ticks into contact with a toxic amount of a formulation comprising:
one or more compounds of structure (I), wherein the compounds of structure (I) comprise: 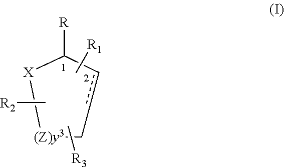
wherein
R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;
X is O or CH₂, with the proviso that when X is O, then R can only be ═O;
each Z is independently selected from the group consisting of (CH) and (CH₂);
y is a numeral selected from 1 and 2;
R₁ is selected from the group consisting of H or a branched or straight chain, saturated or unsaturated hydrocarbyl group with zero to two double bonds and from 1 to 15 carbon atoms;
R₂ is selected from the group consisting of H and a branched or straight chain, saturated or unsaturated hydrocarbyl group with zero to three double bonds and from 1 to 15 carbon atoms;
R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;
the bond between the 2 and 3 positions in the ring structure may be a single or a double bond; and
wherein the compounds of structure (I) contain from 11 to 20 total carbon atoms.

14. The method according to claim 13 wherein the one or more compounds of structure (I) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds; or
wherein the one or more compounds of structure (I) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms; or
wherein the one or more compounds of structure (I) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

15. The method according to claim 13 wherein the one or more compounds of structure (I) are selected from the group consisting of 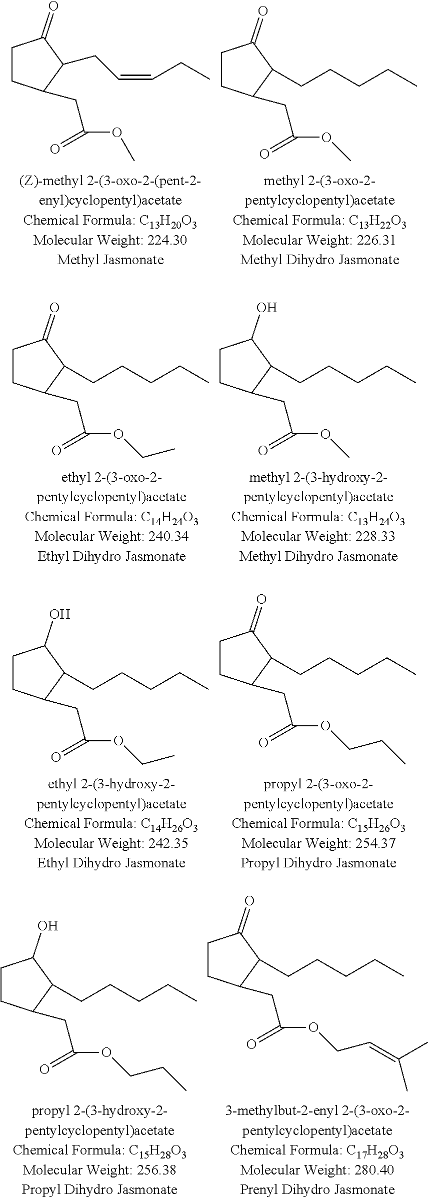 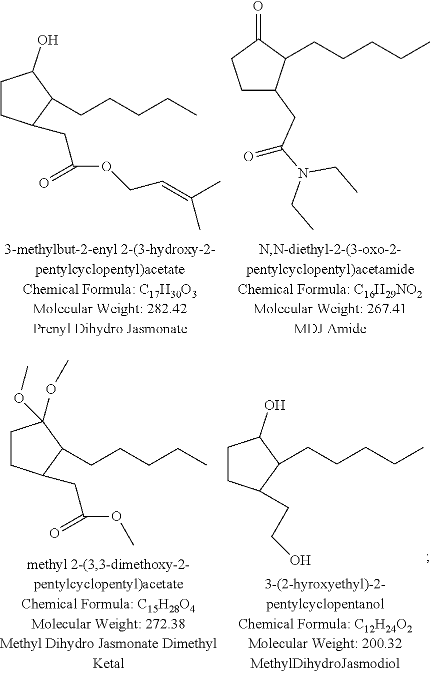
or
wherein the one or more compounds of structure (1) are selected from the group consisting of: 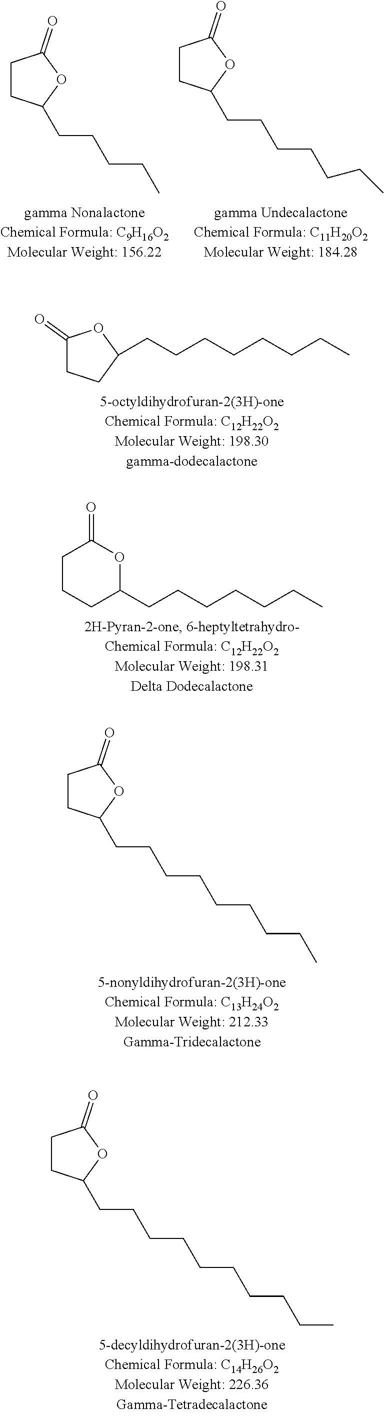 [SMILES: CCCCCC1CCC(=O)O1 ; CCCCCCCC1CCC(=O)O1 ; CCCCCCCCC1CCC(=O)O1 ; CCCCCCCC1CCCC(=O)O1 ; CCCCCCCCCC1CCC(=O)O1 ; CCCCCCCCCCC1CCC(=O)O1] 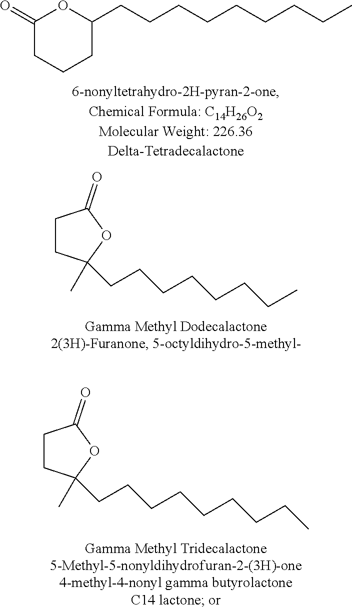 [SMILES: CCCCCCCCCC1CCCC(=O)O1 ; CCCCCCCCC1(C)CCC(=O)O1 ; CCCCCCCCCC1(C)CCC(=O)O1]
wherein the one or more compounds of structure (I) are selected from the group consisting of 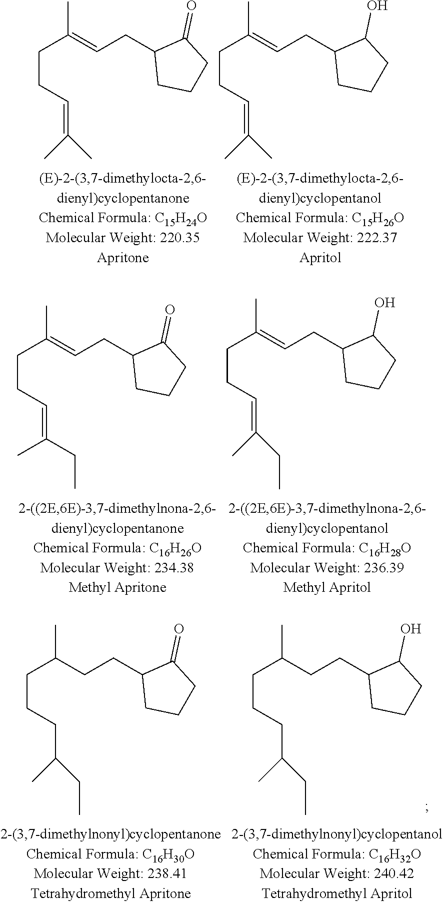
or
wherein the one or more compounds of structure (I) are selected from the group consisting of 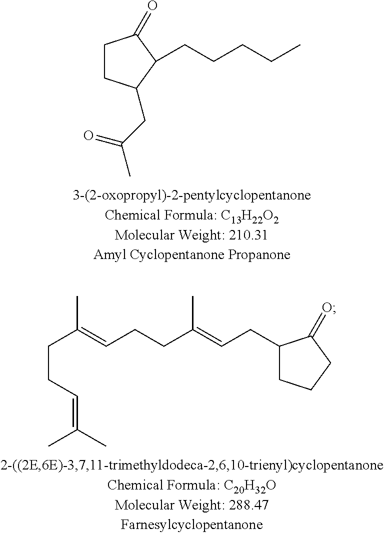 [SMILES: CCCCCC1C(=O)CCC1CC(C)=O ; CC(C)=CCC/C(C)=C/CC/C(C)=C/CC1CCCC1=O]
or
wherein the one or more compounds of structure (I) are selected from the group consisting of

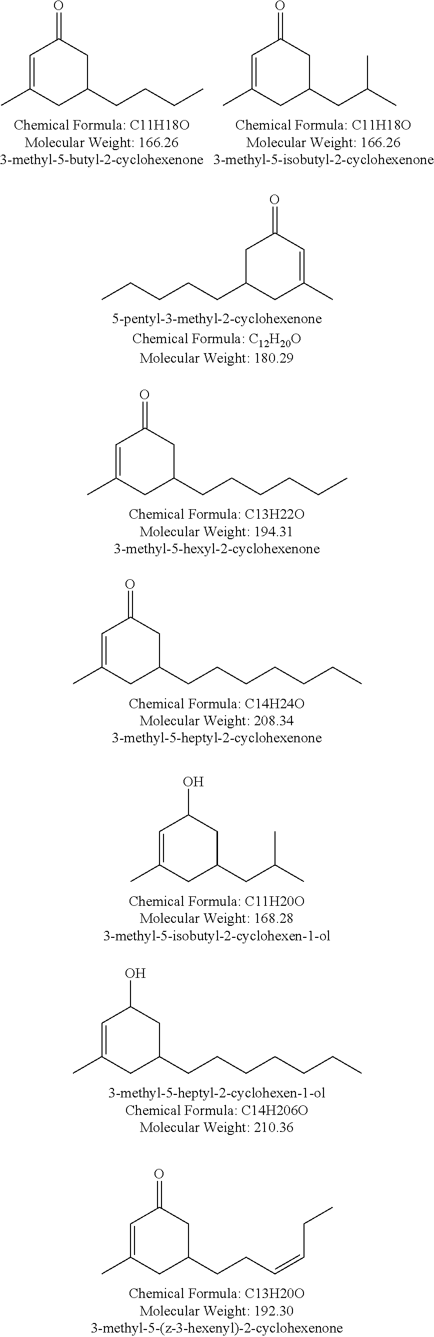

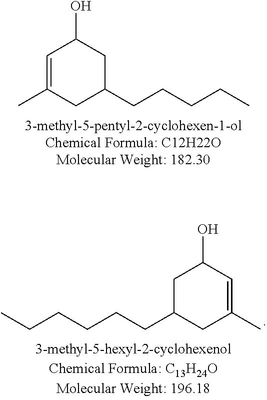

16. The method according to claim 13 wherein the formulation is applied to a surface of or impregnated into clothing of fabric; or
wherein the formulation is applied to detergents, fabric softeners, or dryer sheets; or
wherein the formulation is applied to furniture, building supplies, electronic devices, cargo, or storage areas.

17. The method according to claim 13 wherein the one or more compounds of structure (I) comprise methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone.

18. The method according to claim 13 wherein the formulation is toxic to immature ticks.

19. The method according to claim 13 wherein the formulation is present in an amount from about 0.0001% to about 50% by weight, in a carrier; or
wherein the formulation is applied to a surface of, or impregnated in, clothing or fabric, such that the amount of active material is about 0.0125 g/ft² to about 15 g/ft², or wherein the formulation is applied to an outdoor or indoor surface such that the amount of active material is about 0.125 g/m² to about 150 g/m².

20. The method according to claim 13 wherein the one or more compounds of structure (I) are selected from the group consisting of methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate and delta dodecalactone.
